(19) United States
(12) Patent Application Publication
(10) Pub. No.: US 2026/0012784 A1
(43) Pub. Date: Jan. 8, 2026

(54) MANAGING USER CONSENT FOR ANALYTIC AND EVENT MONITORING OPERATIONS IN A CORE NETWORK

(71) Applicant: GOOGLE LLC, Mountain View, CA (US)

(72) Inventor: Ching-Yu Liao, Mountain View, CA (US)

(21) Appl. No.: 18/992,477

(22) PCT Filed: Jul. 9, 2023
(86) PCT No.: PCT/US2023/069845

§ 371 Date: Jan. 8, 2025

Related U.S. Application Data
(60) Provisional application No. 63/359,758, filed on Jul. 8, 2022.

(51) Int. Cl. H04W 12/02; H04L 41/14; H04L 41/16

(52) U.S. Cl. CPC H04W 12/02; H04L 41/14; H04L 41/16

(57) ABSTRACT

To configure analytics or event monitoring in a mobile communication system, a first network function (NF) of a core network (CN) sends (1002), to a second NF, a request related to an operation involving analytics and/or event monitoring, the request indicating that the operation requires user consent; and receives (1004), from the second NF, a response to the request, the response including user consent information for one or more user equipment units (UEs).

### FIELD OF THE DISCLOSURE

This disclosure relates generally to wireless communications and, more particularly, to managing user consent for analytic and event monitoring operations in a cellular communication networks.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The 3rd Generation Partnership Project (3GPP) recently has begun studying support for Artificial Intelligence (AI)/Machine Learning (AI/ML) based services. In particular, the 3GPP proposes to enable 5G system (5GS) support for assisting AI/ML-enabled applications such as video/speech recognition, robot control, automotive services, etc. Some of these services require AI/ML model distribution to UEs via a 5G network.

According to a scheme which can be referred to as federated learning (FL), participating UEs collaboratively share locally trained AI/ML models and upload these models to an application server via a 5G network. The AS then aggregates the AI/ML models and distributes the aggregated AI/ML model to the UEs joining the federated learning scheme as FL members. The UEs also can upload relatively small updates to the local version of the AI/ML models to the application server, for further integration into the model the application server manages.

The 3GPP recently considered whether and how a 5GS provides assistance to an AI/ML enabled application, which facilitates an FL operation and model distribution/redistribution (e.g., FL members selection, group performance monitoring, adequate network resources allocation and guarantee) between the application clients running on the UEs and the application servers. The 3GPP also considered what information a 5GC requires to assist an application function (AF) in selecting and managing a group of UEs that participate in an FL operation.

However, these developments fail to address the issue of user privacy. According to 3GPP ETSI TS 123.288, v. 17.4.0 (2022-05), the network data analytics function (NWDAF) simply excludes the corresponding SUPI [Subscription Permanent Identifier] from the request to collect data and generate analytics or ML model on the other users for which user consent is granted, if the request is for a group of UE or “any UE.” There are currently no mechanisms for assisting an application with user selection for an application server that relies on analytic and/or event information from the 5GC.

### SUMMARY

An example embodiment of the techniques of this disclosure is a method for configuring analytics or event monitoring in a mobile communication system. The method is implemented in a first network function (NF) of a core network (CN) and comprises sending, from the first NF to a second NF, a request related to an operation involving analytics and/or event monitoring, the request indicating that the operation requires user consent; and receiving, from the second NF, a response to the request, the response including user consent information for one or more user equipment units (UEs).

Another example embodiment of these techniques is a method for managing analytics or event monitoring in a mobile communication system, the method implemented in a first NF of a CN and comprising: subscribing to notifications related to a change in user consent of one or more user equipment units (UEs); and in response to receiving a notification that the user consent of the one or more UEs has changed, notifying at least a second network function (NF) providing a service that involves analytics exposure or event exposure, the service related to the one or more UEs.

Still another example embodiment of these techniques is an NF implemented in a CN that comprises processing hardware, the NF configured to execute one of the methods above.

### BRIEF DESCRIPTION OF THE DRAWINGS

FIG. 1 is a block diagram of an example wireless communication system in which a user equipment units (UEs) participate in federated learning which an application server controls, and a core network (CN) manages user consent related to the federated learning;

FIG. 2 is a block diagram of an example protocol stack according to which the UE of FIG. 1 can communicate with the RAN of FIG. 1;

FIG. 3 is a service-based representation of the 5GS architecture, including the overall non-roaming reference architecture of the policy and charging control framework for the 5GS;

FIG. 4 is a reference-point based representation of the 5GS architecture, including overall non-roaming reference architecture of the policy and charging control framework for the 5GS;

FIG. 5 is a messaging diagram of an example scenario in which a network function transmits a user consent indicator to another network function, to indicate that an operation involving analytics and/or event monitoring requires user consent;

FIG. 6A is a messaging diagram of an example scenario in which a network function subscribes to notifications regarding changes in user consent, in connection with an operation involving analytics;

FIG. 6B is a messaging diagram of an example scenario in which a network function subscribes to notifications regarding changes in user consent, in connection with an operation involving event monitoring;

FIG. 7 is a messaging diagram of an example scenario in which a network function subscribes to notifications for an event associated with mandatory user consent checking;

FIG. 8 is a messaging diagram of an example scenario in which a network function provides a service associated with mandatory user consent checking;

FIG. 9 is a flow diagram for managing user consent information on a per-application basis, which can be implemented in a Unified Data Management (UDM) of the core network of FIG. 1, 3, or 4;

FIG. 10 is a flow diagram of an example method for configuring analytics or event monitoring in a mobile communication system, which can be implemented in a network function (NF) of the core network of FIG. 1, 3, or 4; and

FIG. 11 is a flow diagram of an example method for managing analytics or event monitoring, which can be implemented in a network function (NF) of the core network of FIG. 1, 3, or 4.

### DETAILED DESCRIPTION OF THE DRAWINGS

A third-party application may select a UE as an FL member for an FL operation for supporting an AI/ML-enabled application. To protect user privacy, it is important to ensure that the UE grants user consent to expose, to the third-party application, some of the UE data as part of analytic information.

A network function (NF) operates in a core network (CN) of a cellular communication system and indicates, to another NF, that an operation involving analytics and/or event monitoring requires user consent. The other NF can provide user consent information in response to the indication or in response to a different triggering event. In this manner, the application function (AF) for example can select UEs for a federal learning operation, an AI/ML learning operation, etc. in view of user consent. Further, in some implementations, an NF can subscribe to notifications regarding the change in user consent and notify another NF of the change.

### Example System and Protocol Stack

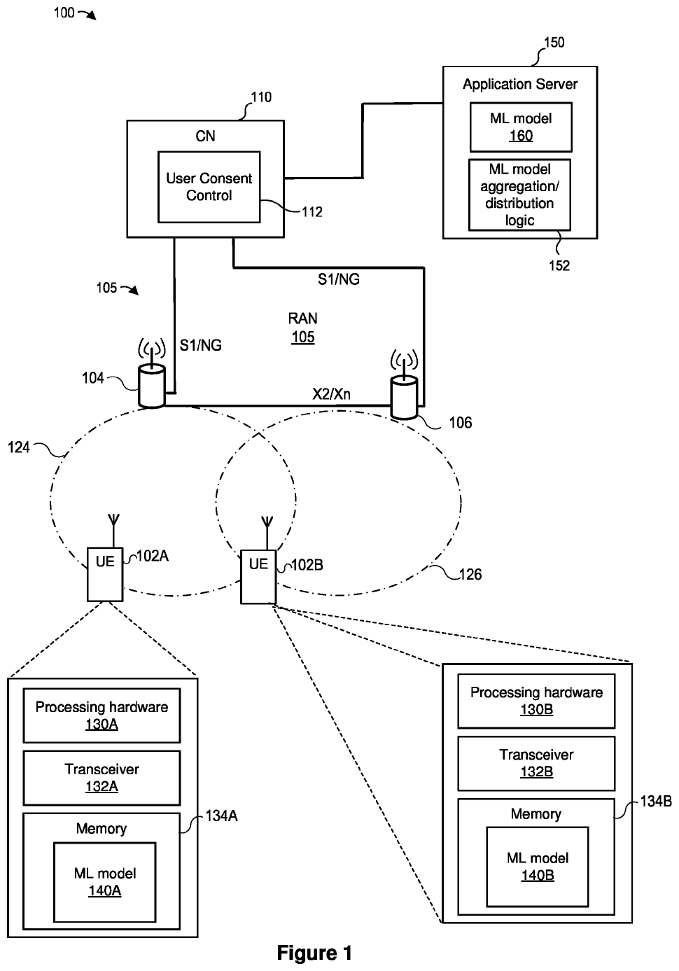

Referring first to FIG. 1, the techniques of this disclosure can be performed by an example wireless communication system 100. The example wireless communication system 100 includes UEs 102A and 102B, a base station (BS) 104, a base station 106, and a core network (CN) 110, such as a fifth generation (5G) core (5GC). The base stations 104 and 106 can operate in a RAN 105 connected to the CN 110. The CN 110 can also be implemented as a sixth generation (6G) core or another suitable core network.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. The cells 124 and 126 can partially overlap, so that the UE 102A or 102B can select, reselect or hands over from one of the cells 124 and 126 to the other. In general, the RAN 105 can include any number of base stations, and each of the base stations can cover one, two, three, or any other suitable number of cells. The UE 102 can support at least a 5G NR (or simply, “NR”) air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

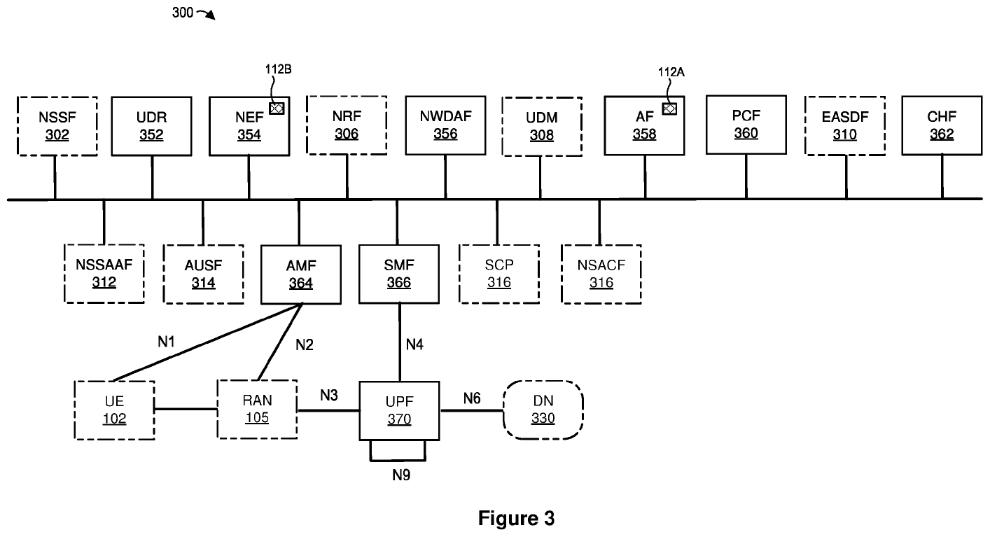

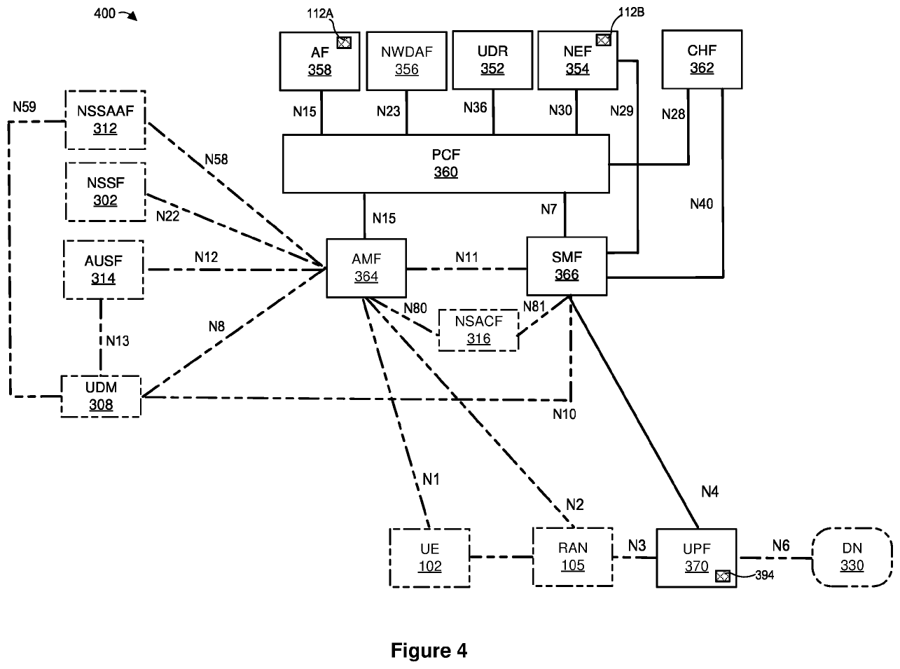

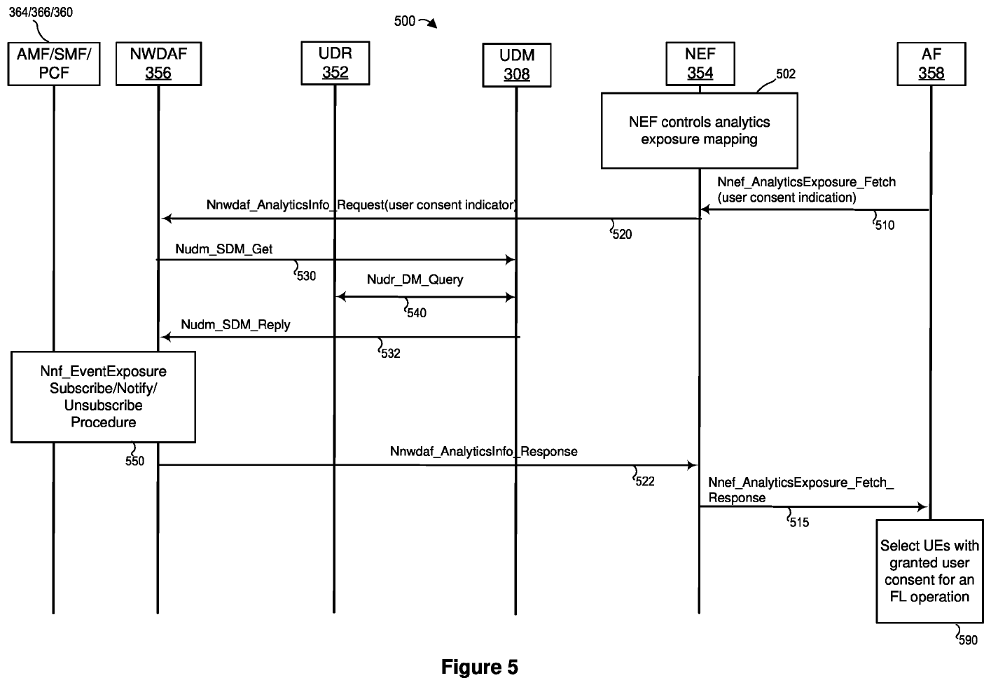

Several NFs that make up the CN 110 are discussed below with reference to FIGS. 3 and 4. One or more of the NFs of the CN 110 implement user consent control logic 112, discussed with reference to FIGS. 5-11.

While not shown in FIG. 1 to avoid clutter, the CN 110 may include processing hardware, which may include one or more general-purpose processors (e.g., CPUs) and a non-transitory computer-readable memory storing instructions that the one or more general-purpose processors execute. Additionally or alternatively, the processing hardware can include special-purpose processing units. The processing hardware may be configured to implement the techniques of this disclosure for enabling 5GS support of advanced media services.

The base station 104 is equipped with processing hardware that can include one or more general-purpose processors (e.g., CPUs) and a non-transitory computer-readable memory storing instructions that the one or more general-purpose processors execute (not shown). Additionally or alternatively, the processing hardware can include special-purpose processing units.

The UE 102A is equipped with processing hardware 130A that can include one or more general-purpose processors such as CPUs and non-transitory computer-readable memory storing machine-readable instructions executable on the one or more general-purpose processors, and/or special-purpose processing units. The UE 102A also includes a transceiver 132A to communicate with the RAN 105 over a radio interface. Further, the UE 102A includes a memory 134A storing an ML model 140A. The UE 102B has a similar implementation and store an ML model 140B.

The UEs 102A and 102B participate in an FL operation, which an application server 150 controls via the CN 110. To this end, the application server 150 implements an ML model aggregation/distribution logic 152. In operation, the application server 150 aggregates the ML model 140A and 140B and/or updates to these models to maintain an ML model 160. The application server 150 also distributes the current version of the ML model 160 to the UEs 102A and 102B.

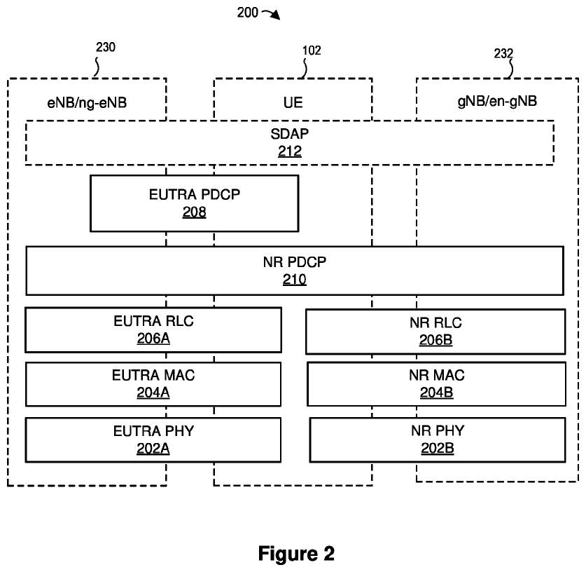

FIG. 2 illustrates, in a simplified manner, an example protocol stack 200 according to which the UE 102 can communicate with an eNB/ng-eNB or a gNB (e.g., one or more of the base stations 104, 106). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 3 is a service-based representation 300 of the 5GS architecture, which the system of FIG. 1 can implement. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSAAF) 312, an Authentication Server Function (AUSF) 314, a Service Communication Proxy (SCP) 316, and a Network Slice Admission Control Function (NSACF) 316. The non-PCC architecture further includes the UE 102, the RAN 105, and a data network (DN) 330.

The PCC framework in the architecture 300 includes a Unified Data Repository (UDR) 352, a Network Exposure Function (NEF) 354, a network data analytics function (NWDAF) 356, an Application Function (AF) 357, a Policy Control Function (PCF) 360, a Charging Function (CHF) 362, an Access & Mobility Management Function (AMF) 364, a Session Management Function (SMF) 366, and a User Plane Function (UPF) 370.

In an example implementation, the AF 358 includes a user consent controller 112A, and the NEF 354 includes a user consent controller 112B. The CN 110 in various implementations can include only the user consent controller 112A, only the user consent controller 112B, or both. The user consent controllers 112A and 112B collectively can be referred to as the user consent control logic 112 of the CN 110.

FIG. 4 is a reference-point based representation 400 of the 5GS architecture. In FIG. 4, the non-roaming reference architecture of the PCC framework for the 5GS is illustrated as blocks and connections with solid lines, and components and connections outside the PCC framework are illustrated using dashed lines.

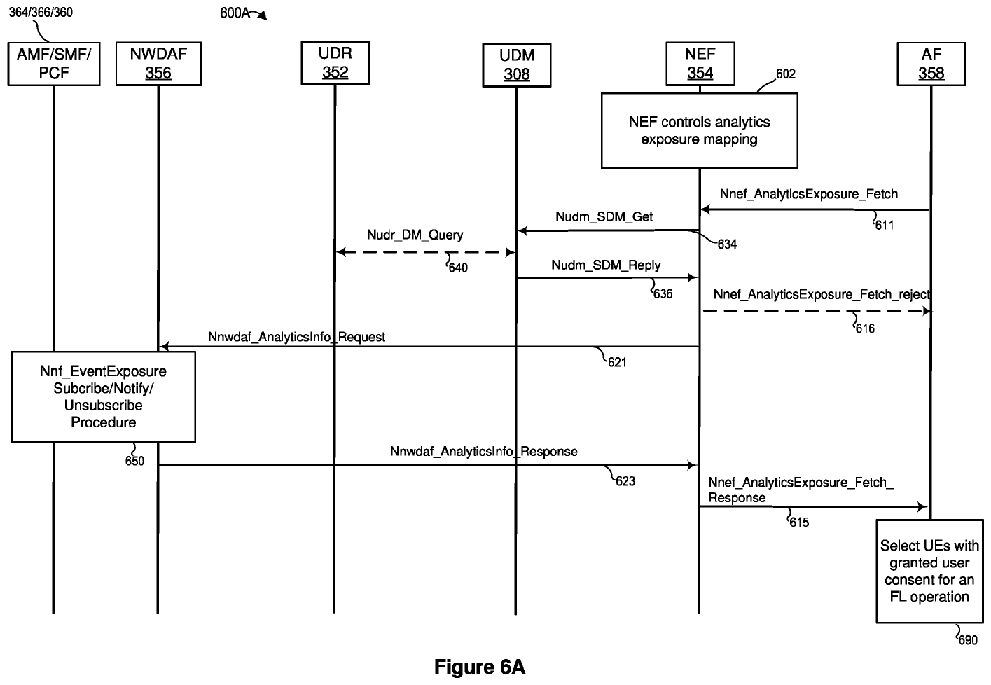

Several example techniques for assisting application with selection of UEs in view of user consent are discussed next. Generally speaking, events in FIGS. 5-11 that are similar are labeled with similar reference numbers (e.g., event 640 of FIGS. 6A and 6B is similar to event 540 of FIG. 5), with differences discussed below where appropriate. With the exception of the differences shown in the figures and discussed below, any of the alternative implementations discussed with respect to a particular event (e.g., for messaging and processing) may apply to events labeled with similar reference numbers in other figures.

FIG. 5 is a messaging diagram of an example scenario 500 in which an NF such as the AF 358 and/or the NEF 354 sends a user consent indicator to another NF, such as the NEF 354 or the NWDAF 356, to indicate that an operation involving analytics and/or event monitoring requires user consent. For simplicity, an operation requiring analytics and/or event monitoring can be referred to below simply as an “analytics operation.” The other NF then can provide user consent information such as a list of UEs with granted user consent, and/or a list of UEs without user consent, to the originating NF, for configuring the analytics operation.

Generally speaking, an AF can send a request similar to that of a procedure for an analytics request by AFs via NEF, a network data analytics requests, or a procedure for analytics subscribe/unsubscribe by AFs via NEF, but here the request includes a user consent indicator to the NEF/NWDAF. In view of the user consent indicator, the NWDAF retrieves the user consent for purpose of data collection from UDM for the Target UE Identifier. Further, the NWDAF can subscribe to UDM service if user consent is changed. If user consent is terminated, the NWDAF terminates the event exposure services provided by other NFs.

In particular, in the scenario 500, the NEF 354 controls 502 the analytics and event exposure mapping. The AF 358 sends 510, to the NEF 354, an Nnef_AnalyticsExposure_Fetch message with a user consent indication as an information element (IE), for example. In another scenario, the AF 358 sends 510 an Nnef_AnalyticsExposure_Subscribe message to the NEF 354. Thus, the AF 358 can send 510 the request similar to a procedure for analytics request by AFs via the NEF, which involves Nnef_AnalyticsExposure_Fetch/Fetch response and Nnwdaf_AnalyticsInfo_Request/Request response messages (see TS 23.288, clauses 6.1.2.1 and 6.1.2.2).

In addition to the user consent indication, the Nnef_AnalyticsExposure_Subscribe message can include an analytics ID(s), a target UE identifier, and validity criteria (e.g., the minimum number of valid UEs for the operation and validity time duration). The AF 358 sends 510 this message with a user consent indicator so as to trigger user consent checking at the NWDAF 356 (see below) and cause the NWDAF 356 to provide a list of UEs with granted user consent (and/or a list of UEs without user consent) to the AF 358 via the NEF 354. The NWDAF 356 provides these list(s) of UEs to the NEF 354/AF 356 along with the analytics result, in some implementations.

The NEF 354 sends 520, to the NWDAF 356, an Nnwdaf_AnalyticsInfo_Request message with a user consent indicator. In another scenario, the NEF 354 sends 520 an Nnwdaf_AnalyticsSubscription_Subscribe message to the NWDAF 356. The message the NEF 354 sends 520 also can include validity criteria received from the AF 358.

In response to receiving 520 the Nnwdaf_AnalyticsInfo_Request message or the Nnwdaf_AnalyticsSubscription_Subscribe message, the NWDAF 356 can check user consent via the UDM 308. The NWDAF 356 can use the Subscription Permanent Identifier (SUPI) in the target UE Identifier for checking user consent. The NWDAF 356 can further stores and/or maintain a list of UEs with granted user consent, and apply the list to the rest of the relevant procedures.

In one implementation, when the request from the AF 358 (event 510) indicates a minimum number of valid UEs, the NWDAF 356 checks how many of the UEs are associated with a granted user consent. The NWDAF 356 continues to service the analytics request if the number of UEs with granted user consent satisfies the minimum number of valid UEs. Otherwise, the NWDAF 356 can wait until the number UEs with granted user consent reaches the minimum number of valid UEs, before proceeding with the servicing of the analytics request. In another implementation, the NWDAF 356 sends a reject message to the NEF 354/AF 358. The reject message can include a list of UEs granted user consent. The reject message also can indicate a cause for the rejection.

The NWDAF 356 sends 530, to the UDM 308, an Nudm_SDM_Get 530 message. The UDM 308 and the UDR 352 communicate 540 as a part of an Nudr_DM_Query process. The UDM 308 then sends 532, to the NWDAF 356, an Nudm_SDM_Reply message. When the NWDAF 356 sends 530 APP_ID to the UDM 308, the UDM 308 queries the UDR 352 to check for the user consent of the application corresponding to the APP_ID. The NWDAF 356 also can subscribe to a UDM service if user consent is changed. Subsequently, if user consent is terminated, the NWDAF 356 can terminate the subscribed Event Exposure services provided by other NFs (e.g., those requested during the procedure 550 discussed below).

With continued reference to FIG. 5, the AMF/SMF/PCF 364/366/360 and the NWDAG 356 perform 550 an Nnf_EventExposureSubscribe/Notify/Unsubscribe procedure. During this procedure, the NWDAF 356 subscribes to the service of Event Exposure provided by the NFs on which user consent changes can have an impact.

The NWDAF 356 sends 522, to the NEF 354, an Nnwdaf_AnalyticsInfo_Response message. In another scenario, the NWDAF 356 sends 522 an Nnwdaf_AnalyticsSubscription_Notify message to the NEF 354. The NWDAF 356 returns 522 the result of analytics, which can include the analytics result and, depending on the implementation, a list of UE that do not have granted user consent or a list of UEs that have granted user consent. The NWDAF 356 can include 522 a cause value with the list of UE that do not have granted user consent.

The NEF 354 then transmits 515, to the AF 358, an Nnef_AnalyticsExposure_Fetch_Response message or an Nnef_AnalyticsExposure_Notify message. The message can include a list of UEs with granted user consent. More generally, the NEF 254 can transmit 515 any suitable user consent information. The AF 358 can select 590 UEs with granted consent for the analytics operation. The operation can be an FL operation for example, and the AF 358 accordingly can select FL members in view of the user consent information.

According to the techniques illustrated in FIGS. 6A and 6B, for Event Exposure or Analytics Exposure scenarios, an NEF can subscribe to UDM service to detect whether user consent is changed. When user consent is terminated, the NEF can terminate the event exposure services provided by other NFs.

FIG. 6A is a messaging diagram of an example scenario 600A in which a network function subscribes to notifications regarding changes in user consent, in connection with an operation involving analytics. More particularly, the NEF 354 can subscribe to a UDM service to receive notifications of changes to user consent. If user consent is terminated, the NEF 354 can terminate the event exposure services provided by other NFs, similar to the corresponding steps in the scenario 500 discussed above.

The AF 358 sends 611 an Nnef_AnalyticsExposure_Fetch message or, in another scenario, Nnef_AnalyticsExposure_Subscribe message to the NEF 354. The message can include an analytics ID, a target UE identifier, a user consent indicator, and validity criteria (e.g. with minimum number of valid UEs and validity time duration). Similar to the scenario 500, the user consent indicator causes the 5GC 110 to enforce user consent checking at the NEF 354 and/or the NWDAF 356, and to provide the analytics result and a list of UEs with granted user consent (or another type of user consent information).

When the NEF 354 the receives 611 the Nnef_AnalyticExposure Fetch request message including the user consent indicator, the NEF 354 can check user consent of the UE per SUPI in the Target UE Identifier, via the UDM 308, and store a list of UEs with granted user consent.

If the NEF 354 provides an APP_ID in a request message, the UDM 308 checks user consent for the indicated application via the UDR 352. The NEF 354 subscribes 634 to a UDM service for notifications regarding changes to user consent. If user consent is terminated, the NEF 354 terminates the subscribed Analytics Exposure or Event Exposure services provided by other NFs. In some implementations, the NEF 354 uses a dedicated event code for the subscription, e.g., “change of user consent.” In particular, the code is specifically defined for the purposes of monitoring changes to user consent, and is distinct from other events, as illustrated in the last row of Table 1 below.

TABLE 1

| | Which NF detects |
|---|---|
| Event | the event |
| Loss of Connectivity | AMF |
| UE reachability | AMF, UDM |
| Location Reporting | AMF, GMLC |
| Change of SUPI-PEI association | UDM |
| Roaming status | UDM |
| Communication failure | AMF |
| Availability after Downlink Data | AMF |
| Notification failure | |
| Change of user consent | UDM |

The NEF 354 sends 616 an Nnef_AnalyticsExposure_Fetch_reject message to the AF 358 if the number of UEs with granted user consent is less than the minimum number of valid UEs corresponding to a validity criterion of the target UE identifier. The NEF 354 also can send a corresponding cause value.

The NEF 354 sends 621 an Nnwdaf_AnalyticsInfo_Request to the NWDAF 356. If the validity criteria indicate a minimum number of valid UEs in Target UE Identifier, the NEF 354 can proceed with the analytics if the number of UEs with granted user consent for the purposes of Analytics Exposure satisfies the minimum number of valid UEs.

With continued reference to FIG. 6A, the NWDAF 356 subscribes 650 to the service of Event Exposure provided by the impacted NFs. The NWDAF 356 sends 623 an Nnwdaf_AnalyticsInfo_Response message to NEF 354 to return the result of the analytics. In another scenario, the NWDAF 356 sends 623 an Nnwdaf_AnalyticsSubscription_Notify message with an analytics result.

The NEF 354 sends 615 an Nnef_AnalyticsExposure_Fetch_Response message (or, in another scenario, Nnef_AnalyticsExposure_Notify) to the AF 358 and includes the analytics results along with a list of UEs with granted user consent.

FIG. 6B is a messaging diagram of an example scenario 600B which is generally similar to the scenario 600A of FIG. 6A, except that here the AF 358 sends 612 an Nnef_EventExposure_Subscribe/Unsubscribe_request message to the NEF 354. The NEF 354 optionally sends 617 an Nnef_EventExposure_Subscribe/Unsubscribe_response/reject message, and sends 618 an Nnef_EventExposure_Subscribe/Unsubscribe_response or Nnef_EventExposure_Notify message to the AF 358, to respond to the message of event 612.

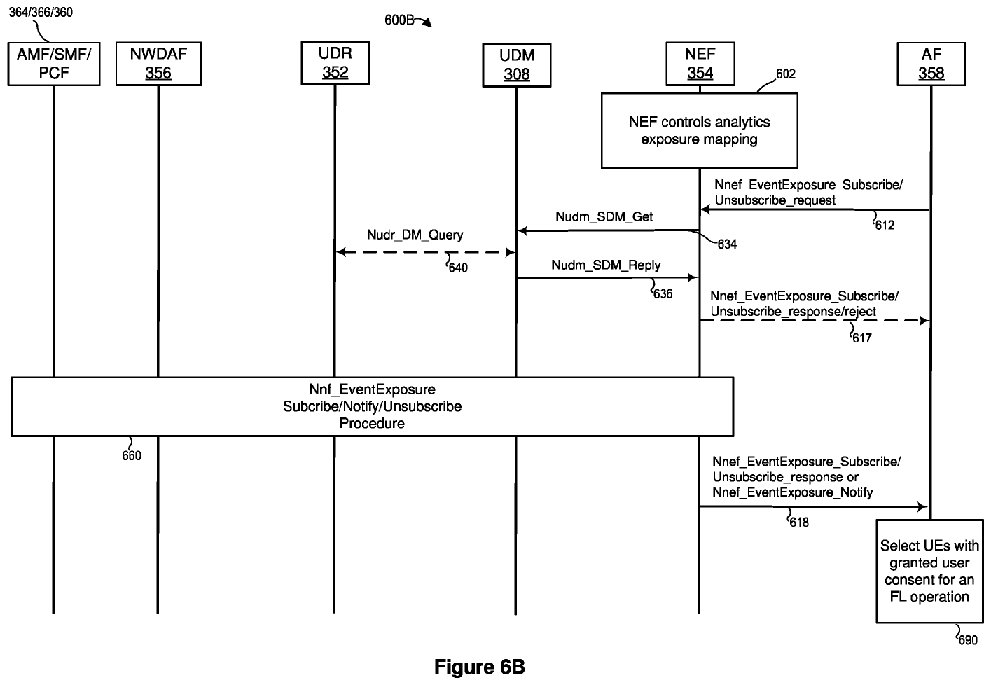

Next, FIG. 7 is a messaging diagram of an example scenario 700 in which an NF subscribes to notifications for an event associated with mandatory user consent checking. To this end, the NF can use the event ID specified in the last row of Table 1 above. More specifically, Event Exposure procedures can expose this event ID to the AF 358. The NEF 354 further can subscribe to a UDM service for notifications related to user consent changes, similar to the examples discussed above. If user consent is terminated, the NEF 354 can terminate the event exposure services provided by other NFs.

Thus, the AF can effectively operate as a service consumer using an NEF service, for a target UE identifier corresponding to one UE or a group of UEs.

The AF 358 sends 712 an Nnef_EventExposure_Subscribe/Unsubscribe_request message to the NEF 354. The message can include the dedicated event ID (e.g., “change of user consent”), to request an Event Exposure procedure. The message also can include a target UE identifier and validity criteria (e.g., the minimum number of valid UEs and validity time duration). The event identifier in the message causes the 5GC 110 to enforce user consent checking at the NEF 354. Thus, the AF 358 indicates that the analytics operation requires user consent by including a dedicated event identifier in a subscription message.

When the NEF 354 receives the dedicated event identifier corresponding to user consent checking, the NEF 354 checks user consent of the UE via the UDM 308, which can be based on the SUPI in the target UE identifier. The NEF 354 can store the list of UEs with granted user consent.

If the NAF provided 733 an APP_ID in the request message, the UDM 308 can also check 740 for the user consent of the indicated application, via the UDR 352. The NEF 354 can subscribe to a UDM service for monitoring changes to user consent. If user consent is terminated, the NEF 354 can terminate the subscribed Analytics Exposure or Event Exposure services provided by other NFs.

If the number of UEs with granted user consent is less than the number included in the validity criteria of valid UEs specified in target UE identifier, the NEF 354 can return a reject message to the AF 358, and include a list of UEs with granted user consent along with a corresponding cause.

The NEF 354 can send 718, to the AF 358, an Nnef_EventExposure_Subscribe/Unsubscribe_response message including a list of UEs with granted user consent to the AF 358.

The AF 358 can maintain 780 a list of UEs with granted user consent and apply this list to the remaining steps of the procedure. If the number of UEs with granted user consent for the purposes of Event Exposure and Analytics Exposure satisfies the requirement of minimum number of valid UEs, the AF 358 proceeds with the analytics. Otherwise, the AF 358 in some implementations waits until the NEF 354 notifies the AF 358 of the required number of UEs with granted user consent.

The AF 358 then can perform procedures for Analytics Exposure, Event Exposure, or both with the NEF 354, based on the list of UEs with granted user consent, which the AF 358 maintains 780.

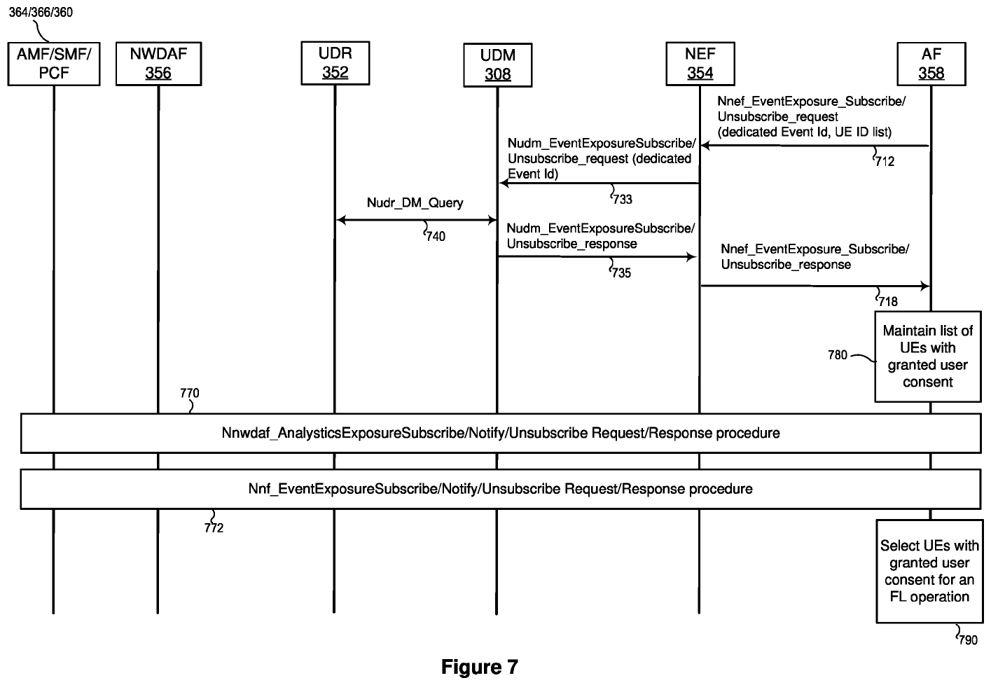

Next, FIG. 8 illustrates a technique according to which an AF can request information exposure of UE for either Event Exposure using event identifier, Analytics Exposure via exposure identifier, or both. As part of the procedure, the NEF checks user consent of a target UE identifier, which can correspond to a single UE or multiple UEs, before proceeding to a request of exposure of data for other NFs, including AMF/SMF/PCF/NWDAF. This procedure can be understood as a procedure for generic information exposure towards NFs including both of NWDAF and NFs (AMF/SMF/PCF), with an NEF service dedicated to checking user consent

In particular, the AF 358 sends 813 a message dedicated for the purposes of this scenario to the NEF 354. The message can be called Nnef_InfoExposureSubscribe/Unsubscribe_request, for example. The AF 358 indicates 813 in this message one or more event identifier(s), an analytics identifier, or both. The AF 358 can further indicate 813 a UE identifier, and APP_ID. The AF 358 also can indicate validity criteria (e.g. the minimum number of valid UEs and validity time duration). The dedicated message InfoExposureSubscribe causes the 5GC 110 to enforce user consent checking at the NEF 354.

In response to receiving 813 the Nnef_InfoExposureSubscribe/Unsubscribe_request message, the NEF 354 can initiate user consent checking via the UDM 308, which can be based on the SUPI in the target UE identifier. The NEF 354 can store the list of UEs with granted user consent.

If the NEF provides 843 an APP_ID, the UDM 308 also checks, via the UDR 352, for user consent of the indicated application. The NEF 354 can subscribe to a UDM service for notifications regarding changes to user consent. If user consent is terminated, the NEF 354 can terminate the subscribed Analytics Exposure or Event Exposure services provided by the other NFs.

If the number of UEs with granted user consent is less than the minimum number of valid UEs associated with the validity criteria in the target UE Identifier, the NEF 354 can wait, according to the validity time indicated 813 in AF request, until the UDM 308 notifies the NEF 354 of the required number of valid UEs, and then continues with the analytics.

The NEF 254 can skip procedures 874 and 876 and send 814 a Nnef_InfoExposureSubscribe response message to the AF 358. The message can indicate the result of the exposure services subscription and, if there is an insufficient numbers of UEs with granted user consent, a corresponding cause.

The NEF 354 can maintain the list of UEs with granted user consent and apply this list in the procedures 874 and 876, if the number of UEs with granted user consent is equal or greater than the minimum number of valid UEs.

The NEF 354 responds 819 to the AF 358 in an Nnef_InfoExposure Notify message, if the NEF 354 receives a notification from a subscribed services of the NFs, including the NWDAF 356, the AMF 364, the UDM 308, the SMF 366, or the PCF 360.

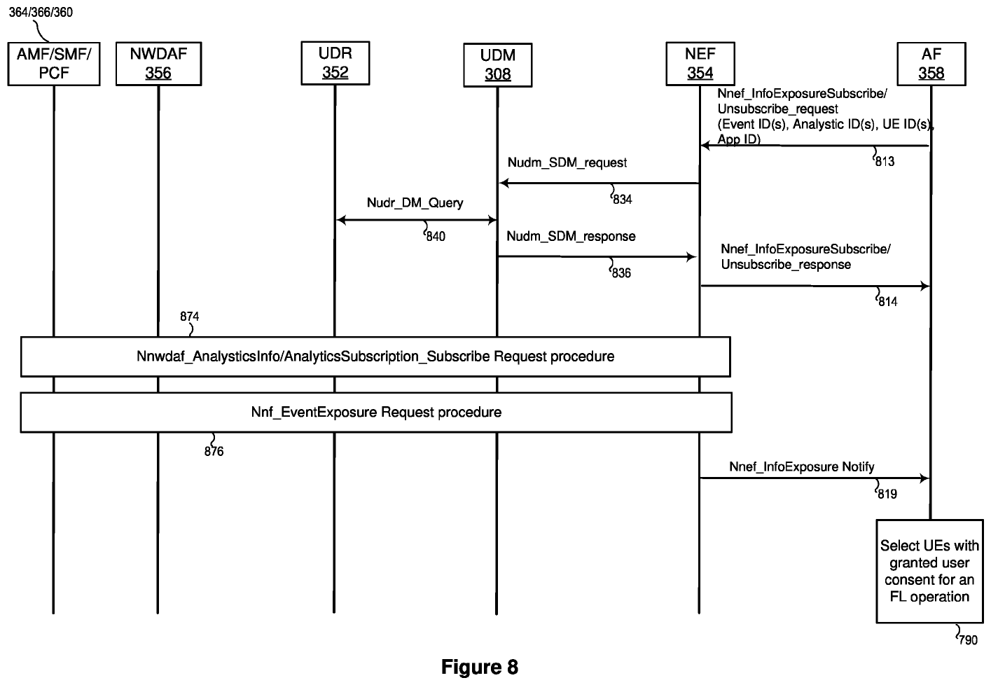

FIG. 9 is a flow diagram for managing user consent information on a per-application basis, which can be implemented in the UDM 308 for example. This technique, according to which user consent is associated with an Application Identifier, can be used along with the techniques discussed above.

At block 902, the UDM 308 can receive subscription information including an APP_ID. At block 904, the UDM 308 stores user consent per application identifier via the UDR 352, as part of application subscription. In this implementation, a user consent field can indicate whether user consent is granted or not granted for a certain application, and the sub-data key in this case is application identifier (or APP_ID). Further, user consent of the UE for a purpose other than exposing UE data to a 3rd party, per application identifier, can be stored at the UDM 308/UDR 252 as part of UE subscription.

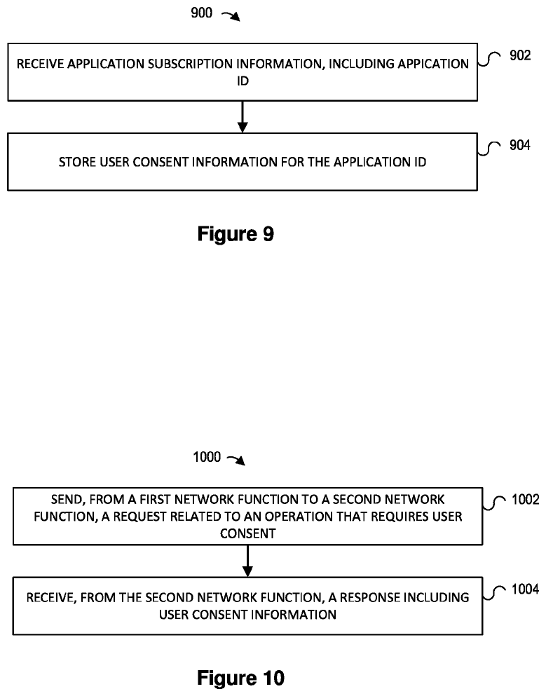

FIG. 10 is a flow diagram of an example method 1000 for configuring analytics or event monitoring in a mobile communication system, which can be implemented in an NF such as the AF 358 of the NEF 354, for example. At block 1002, the first NF sends, to a second NF, a request related to an operation that requires user consent (see, e.g., events 510, 520, 611, 612, 630, 712, 733, 813, 836). At block 1004, the first NF receives, from the second NF, a response including user consent information (see, e.g., events 515, 522, 615, 618, 632, 735, 718, 819, 837).

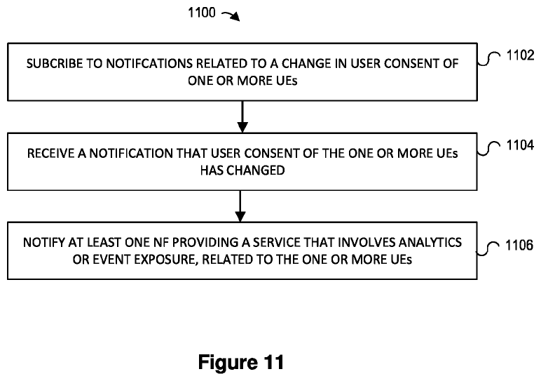

FIG. 11 is a flow diagram of an example method 1100 for managing analytics or event monitoring, which can be implemented in the NEF 354 or another suitable NF. At block 1102, the NF subscribes to notifications related to a change in user consent of one or more UEs (see, e.g., event 630). At block 1104, the NF receives a notification of a change in user consent for one or more UEs related to an analytics function (see, e.g., event 632). At block 1106, the NF notifies at least one other NF of the change in user consent (see, e.g., events 615, 616).

As discussed below, various techniques of this disclosure involve messaging between network functions of the 5GS (e.g., network functions of the CN 110), and between the CN (e.g., the CN 110) of the 5GS, the RAN (e.g., the RAN 105), and the UE (e.g., 102).

The following list of examples reflects a variety of the embodiments explicitly contemplated by the present disclosure:

Example 1. A method for managing analytics or event monitoring in a mobile communication system, the method implemented in a first network function (NF) of a core network (CN) and comprising: subscribing to notifications related to a change in user consent of one or more user equipment units (UEs); and in response to receiving a notification that the user consent of the one or more UEs has changed, notifying at least a second network function (NF) providing a service that involves analytics exposure or event exposure, the service related to the one or more UEs.

Example 2. The method of example 1, further comprising: when the notification indicates termination of the user consent, terminating the service provided by the second NF.

Example 2. The method of example 1, further comprising: in response to determining that a number of the UEs with granted user consent is below a minimum number associated with a validity criterion of the service, sending a reject message to the second NF.

Example 4. The method of example 3, wherein the reject message includes a list of UEs with granted user consent.

Example 5. The method of example 3, wherein the reject message includes a reject cause related to the change in the user consent.

Example 6. The method of any of the preceding examples, wherein: the first NF is a network exposure function (NEF); and the subscribing includes configuring a Unified Data Management function (UDM) to send the notifications to the NEF.

Example 7. The method of any of the preceding examples, further comprising: receiving, from the second NF, a request related to the service; wherein the subscribing is response to the request from the second NF.

Example 8. The method of example 7, the request is an Nnef_AnalyticExposure_Fetch request.

Example 9. The method of example 7 or 8, wherein the request indicates that the service requires the user consent.

Example 10. The method of any of examples 7-9, further comprising, in response to receiving the request from the second NF: checking the user consent using the UDM; and storing a list of UEs with granted user consent.

Example 11. The method of example 10, wherein the checking is based on a target UE identifier associated with a Subscription Permanent Identifier (SUPI).

Example 12. The method of any of the preceding examples, wherein the second NF is an application function (AF).

Example 13. The method of any of the preceding examples, wherein the notification is associated with an event identifier dedicated to indicating changes in the user consent.

Example 14. The method of any of the preceding examples, wherein: the subscribing includes indicating an application associated with the service, to which the user consent relates.

Example 15. A method for configuring analytics or event monitoring in a mobile communication system, the method implemented in a first network function (NF) of a core network (CN) and comprising: sending, from the first NF to a second NF, a request related to an operation involving analytics and/or event monitoring, the request indicating that the operation requires user consent; and receiving, from the second NF, a response to the request, the response including user consent information for one or more user equipment units (UEs).

Example 16. The method of example 15, wherein the request related to the operation includes a field dedicated to conveying a user consent indicator.

Example 17. A network function (NF) implemented in a core network (CN) that comprises processing hardware, the NF configured to execute a method of any of the preceding examples.

The following description may be applied to the description above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method for configuring analytics or event monitoring in a mobile communication system, the method implemented in a first network function (NF) of a core network (CN) and comprising:
sending, from the first NF to a second NF, a request related to an operation involving analytics and/or event monitoring, the request indicating that the operation requires user consent; and
receiving, from the second NF, a response to the request, the response including user consent information for one or more user equipment units (UEs).

2. The method of claim 1, wherein:
the first NF is an application function (AF); and
the second NF is a Network Exposure Function (NEF).

3. The method of claim 1 or 2, further comprising:
selecting, based on the response, a group of UEs for the operation.

4. The method of any of the preceding claims, wherein the operation relates to federated learning.

5. The method of any of the preceding claims, wherein:
the request related to the operation is an event notification request including an event identifier corresponding to a procedure with mandatory event.

6. The method of any of the preceding claims, wherein:
the request related to the operation is associated with a procedure with mandatory verification of user consent at the NEF.

7. The method of claim 1, wherein:
the first NF is an NEF; and
the second NF is a Network Data Analytic Function (NWDAF).

8. The method of any of the preceding claims, wherein the request related to the operation includes one of:
(i) a request to receive analytics information, or
(ii) a request to subscribe to analytics information.

9. The method of any of the preceding claims, wherein the response includes at least one of:
(i) a list of UEs for which user consent has been granted, or
(ii) a list of UEs for which user consent has not been granted.

10. The method of claim 1, 2, or 7, further comprising:
subscribing to notifications related to changes in user consent of the one or more UEs.

11. The method of claim 10, wherein:
the subscribing includes configuring a Unified Data Management function (UDM) to send the notifications to the first NF.

12. The method of claim 10 or 11, wherein:
the subscribing includes indicating an application associated with the operation, to which the user consent relates.

13. The method of any of claims 10-12, further comprising:
receiving a request for analytics fetching or subscription,
wherein the subscribing is in response to the receiving of the request.

14. The method of any of claims 10-12, further comprising:
receiving a request for event monitoring fetching or subscription,
wherein the subscribing is in response to the receiving of the request.

15. A network function (NF) implemented in a core network (CN) that comprises processing hardware, the NF configured to execute a method of any of the preceding claims.
